(19) United States
(12) Patent Application Publication
(10) Pub. No.: US 2013/0068398 A1
(43) Pub. Date: Mar. 21, 2013

(54) Enclosure for Roller Blinds or the Like

(71) Applicants: Norman Wills, Mississauga (CA); Philip Ng, Thornhill (CA)

(72) Inventors: Norman Wills, Mississauga (CA); Philip Ng, Thornhill (CA)

(21) Appl. No.: 13/236,376

(22) Filed: Sep. 19, 2011

(51) Int. Cl. E06B 9/42

(52) U.S. Cl. 160/26

(57) ABSTRACT

A head box for receiving one or more roller blinds or the like. The head box comprises a pair of end plates, a front closure panel and a bottom closure panel to at least partially enclose the bottom of said head box. The end plates support one or more roller blinds when the roller blinds are received within the head box. The front closure panel extends between the end plates and is releasably securable thereto. The bottom closure panel is releasably securable to the front closure panel.

### FIELD

This invention relates generally to head boxes or enclosures that may be used for receiving or concealing roller blinds, shades and other forms or types of window coverings.

### BACKGROUND

Typically, roller blinds and window shades are either mounted externally to a window frame or internally within the limits of the frame. However, in some instances it is desirable to recess blinds or shades within a ceiling or bulkhead. Such is commonly the case in condominium and commercial construction where window glass may extend upwardly to, or near, an interior ceiling, and where it is often desirable for the blind or shade to extend downwardly from the ceiling surface. In such instances, it is common to utilize an enclosure (or what is sometimes referred to as a pocket or head box), having enclosed ends, an enclosed front, an enclosed back, enclosed top surface and a generally open bottom. The head box is recessed into the ceiling or bulkhead structure so that its lower surface is at essentially the same elevation as that of the lower surface of the ceiling or the bulk head. The roller blind or shade may then be mounted within the head box to conceal it from sight and to permit the blind or shade to be lowered vertically downward through the head box's open lower surface. In some instances, a bottom plate is utilized in conjunction with the head box in order to partially close the open bottom surface and further obscure the roller blind or shade and hardware from view.

Conventionally, such enclosures or head boxes have been formed through the use of extruded aluminum in order to present a sufficiently rigid structure that is able to carry and support the roller blind or shade. It is also conventional for the front of such enclosures or head boxes to be a rigid solid plate that provides support from which a bottom plate can be suspended. Typically, bottom plates of head boxes or roller blind enclosures must remain removable to allow for access into the interior of the enclosure for purposes of mounting and/or servicing the blind hardware. Since in some instances the enclosures or head boxes can be many feet in length, the front surface or front panel of the enclosure must be rigid enough to carry the weight of the bottom enclosing plate.

While the manufacture of such enclosures or head boxes is neither difficult nor mechanically complex, the result is an extruded aluminum structure that, on account of its relatively significant weight and the volume of aluminum required for its manufacture, presents an end product that is of significant expense. Accordingly, there is a need for an enclosure or head box that can be utilized to house roller blinds or shades that is lighter and less expensive, while still maintaining sufficient structural rigidity to support the blinds or shades that it will house, and to further support a removable lower enclosure plate.

### SUMMARY

The invention therefore provides an improved enclosure or head box that addresses some of the deficiencies or limitations of currently available products.

Accordingly, in one of its aspects the invention provides a head box for receiving one or more roller blinds or the like, the head box comprising a pair of end plates, said end plates supporting one or more roller blinds when said roller blinds are received within said head box; a front closure panel, said front closure panel extending between said end plates and releasably securable thereto; and a bottom closure panel to at least partially enclose the bottom of said head box, said bottom closure panel releasably securable to said front closure panel.

In a further aspect the invention concerns a head box for receiving one or more roller blinds or the like, the head box comprising two or more end plates, said end plates supporting one or more roller blinds when said roller blinds are received within said head box; a front closure panel, said front closure panel extending between said end plates and releasably securable thereto, said end plates including a biasing means engaging said front closure panel when said front closure panel is releasably secured to said end plates, said biasing means helping to prevent the unintentional disengagement of said front closure panel from said end plates; and, a bottom closure panel to at least partially enclose the bottom of said head box, said bottom closure panel releasably securable to said front closure panel.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a side sectional view of an enclosure or head box for a roller blind or the like, constructed in accordance with one of the preferred embodiments of the invention, shown mounted in a ceiling or bulkhead;

FIG. 2 is a front side perspective view of the enclosure or head box shown in FIG. 1;

FIG. 3 is a rear side perspective view of the enclosure or head box shown in FIG. 1;

FIG. 4 is a vertical sectional view taken along the line 4-4 of FIG. 2;

FIG. 5 is an exploded view of the enclosure or head box shown in FIG. 4 with the bottom closure plate removed and the front closure plate disengaged from the end plates;

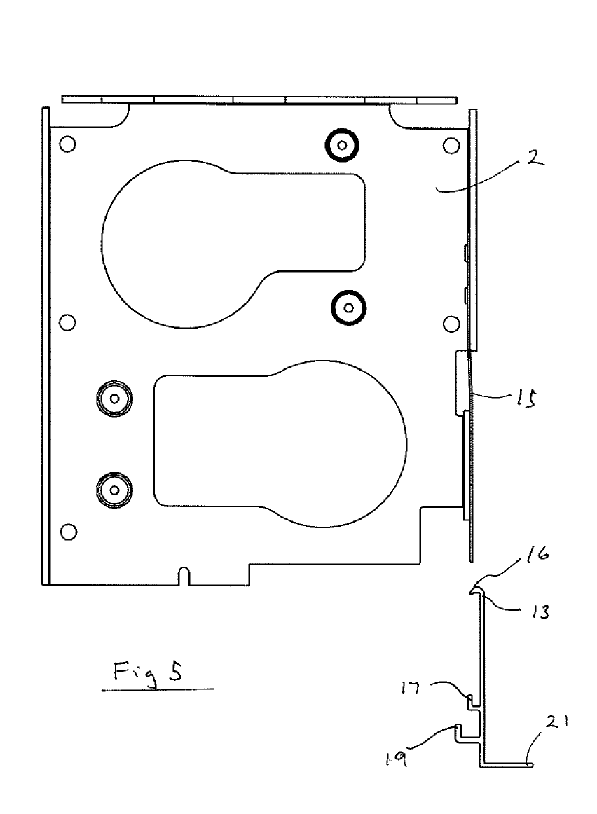

FIG. 6 is a view subsequent to that shown in FIG. 5 wherein the front closure plate is partially engaged with the end plates; and

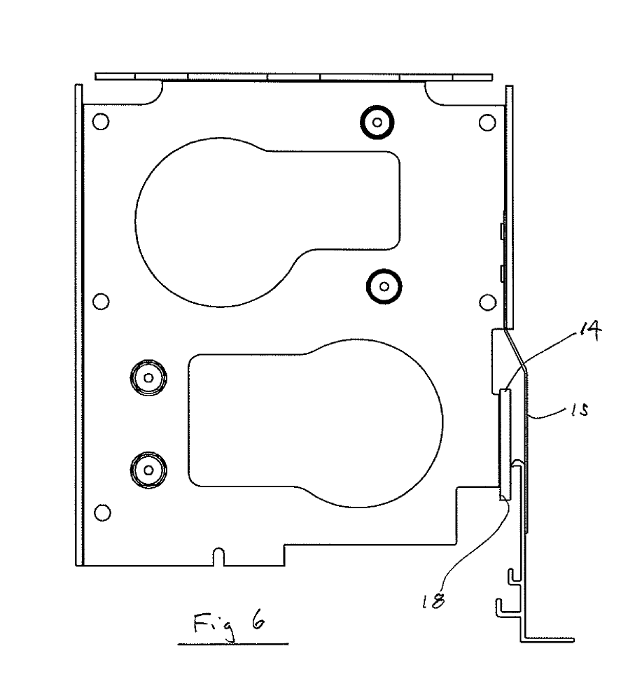

FIG. 7 is a view subsequent to that shown in FIG. 6 wherein the front closure plate is fully engaged with the end plates.

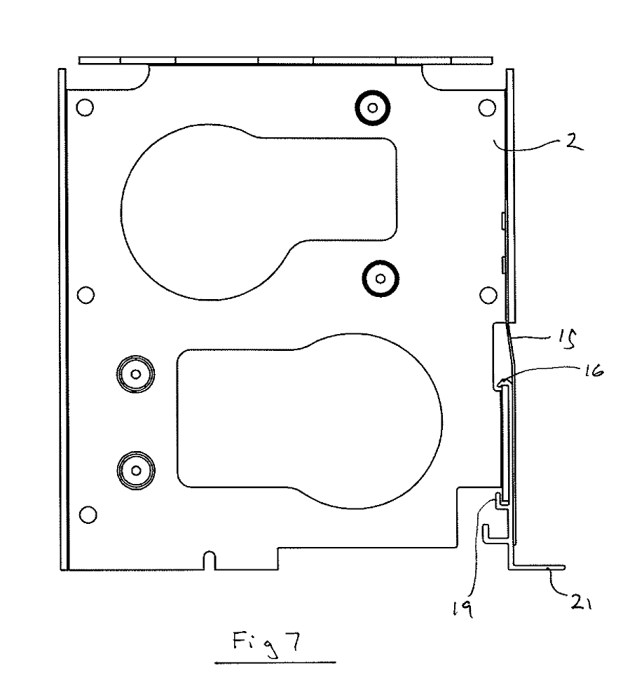

### DESCRIPTION

The present invention may be embodied in a number of different forms. However, the specification and drawings that follow describe and disclose only some of the specific forms of the invention and are not intended to limit the scope of the invention as defined in the claims that follow herein.

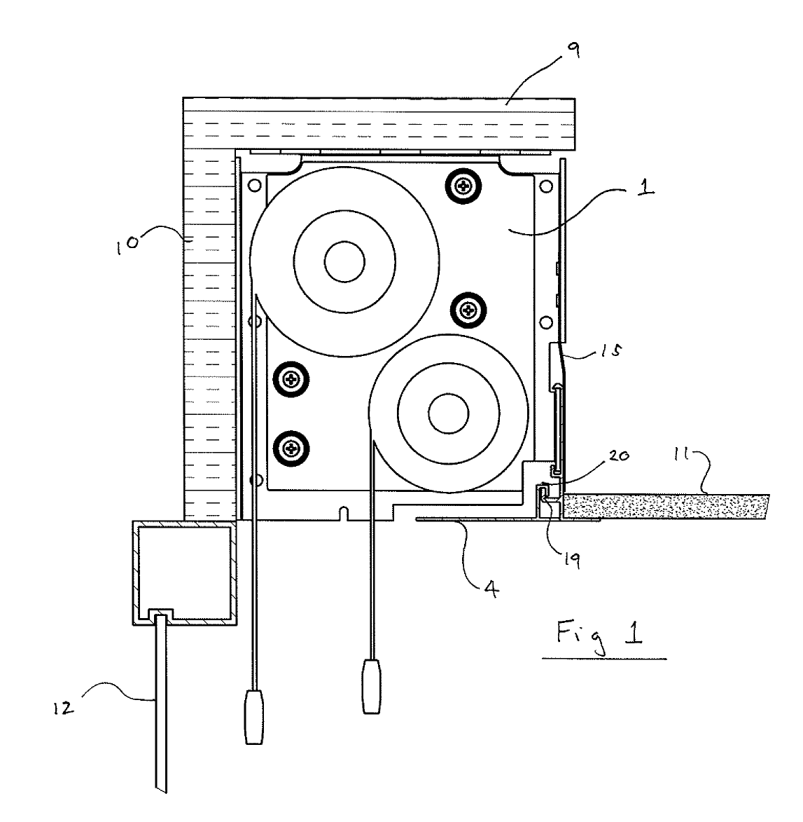

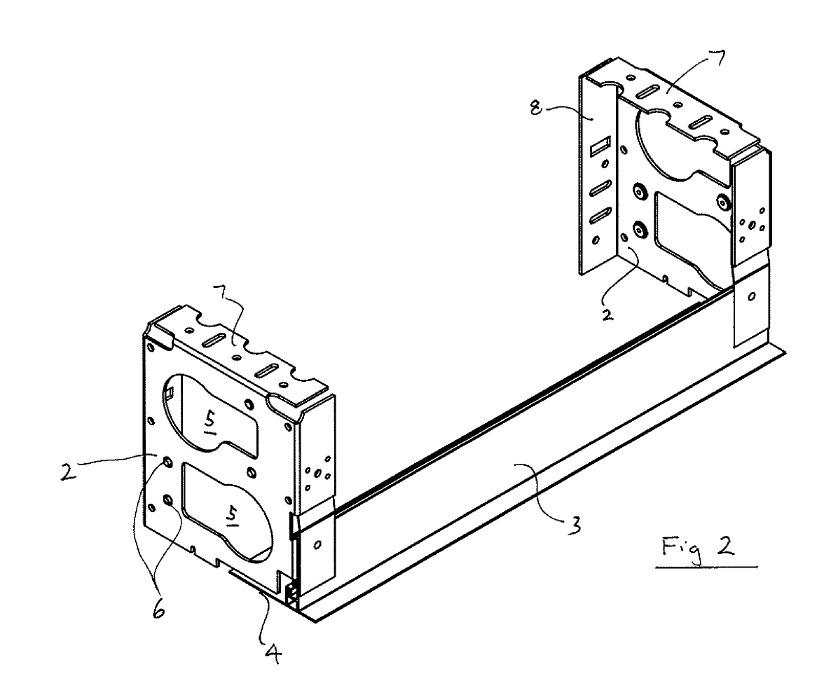

With reference to the attached drawings, a roller blind enclosure (hereinafter referred to as a head box) constructed in accordance with one of the preferred embodiments of the invention is noted generally by reference numeral 1. Head box 1 is constructed to receive one or more roller blinds, window shades or similar or related window coverings such that the blind or shade hardware, and the blind or shade itself when not deployed, is received within the head box and generally obscured from view. With particular reference to FIGS. 1 and 2, head box 1 is comprised generally of a pair of end plates 2, a front closure panel 3 and a bottom closure panel 4. In a preferred embodiment the head box has a generally open upper top and a generally open back or rear. That is, as is specifically shown in FIG. 2, the upper or top portions of end plates 2, as well as the back or rear portions of the end plates, are in the depicted embodiment not connected to one another such that the top and back portions of the head box are open. It will, however, be appreciated from a thorough understanding of the invention that in alternate embodiments of the invention the top and rear surfaces could be enclosed if desired or could be comprised of longitudinally oriented structural members that at least partially enclose the top and rear surfaces or areas.

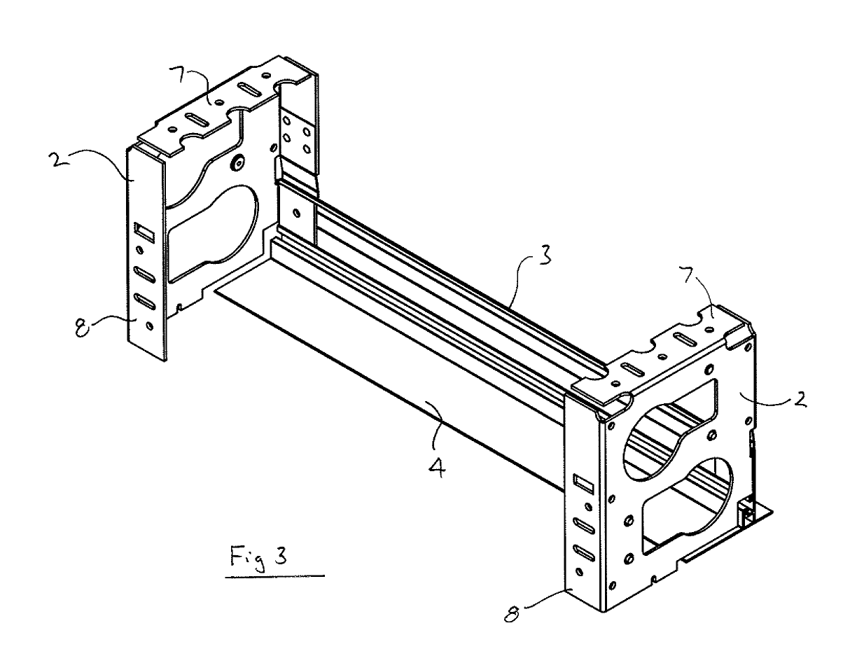

One of the primary functions of end plates 2 will be to support the one or more roller blinds that are received within head box 1. For that reason, the end plates will in most cases be designed in order to accept various forms of hardware that may be used to mount and secure the ends of roller blinds within the head box. End plates 2 will thus typically include openings 5 for receiving roller blind hardware and the ends of the roller blinds. The end plates may also contain a variety of threaded bores 6 to assist in the mounting of blind hardware. As is particularly shown in FIGS. 2 and 3, end plates 2 will also preferably include upper and rear fastening flanges, 7 and 8 respectively, that are oriented generally perpendicular to the ends of the end plates and through which screws, nails or other fasteners may pass in order to mount and secure the head box to structural members within a wall, ceiling, bulkhead, etc. An example of one method of mounting head box 1 within a ceiling is shown in FIG. 1. Here, head box 1 is mounted within the ceiling with endplates secured to structural members 9 and 10. The ceiling surface 11 (which may be drywall or tile) is shown generally as abutting front closure panel 3. In this particular embodiment two roller blinds are shown mounted within the head box such that upon their deployment the blinds extend vertically downward in front of window 12.

In accordance with an embodiment of the invention front closure panel 3 extends between the end plates and is releasably securable thereto. For that purpose the front closure panel has an end plate engaging member 13 along its upper edge. The end plate engaging member 13 is receivable over a generally vertical flange 14 on the end plates, allowing front closure panel 3 to effectively hang from the flanges on the end plates. End plates 2 further include a biasing means 15 that engages front closure panel 3, when hung from the flanges on the end plates, in order to help securely hold the front closure panel in place and to help prevent the unintentional removal of end plate engaging member 13 from flanges 14. In most instances biasing means 15 will be a spring that is secured to the end plate and that bears against the outer surface of front closure panel 3. While many forms of springs may be utilized, in the embodiment shown in the attached drawings the spring is a highly resilient metal that generally lies flat across the outer face of front closure panel 3 in order to apply a generally horizontally oriented biasing force to the panel, thereby assisting and maintaining it in place.

To further help assist in maintaining front closure panel 3 in position when it is secured to end plates 2, end plate engaging member 13 may be in the form of a hook-like member that is received over the upper edges of flanges 14. In such an instance removal of the front enclosure panel will thus require the application of a force to offset the biasing force applied by spring or biasing means 15 as well as a dislodging of hook-like member 16 from flanges 14.

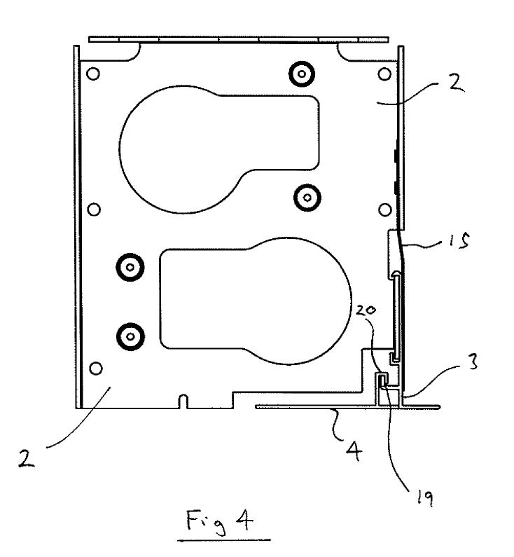

In an embodiment of the invention, front closure panel 3 further includes a lower track 17 that engages a generally downwardly oriented flange portion 18 on each of the end plates 2. As is shown in FIG. 4, when the front closure plate is retained in place, flanges 18 will be received within track 17 helping to prevent the horizontal displacement of the lower portion of the front closure panel from end plates 2.

As discussed above, head box 1 includes a bottom closure panel that at least partially encloses the bottom of the head box to help obscure the roller blinds and roller blind hardware from exterior view. Bottom closure panel 3 is preferably releasably securable to front closure panel 3. To that end, front closure panel 3 includes a generally upwardly oriented rail member 19 and bottom closure panel 4 includes a generally downwardly oriented hook member 20. Hook member 20 may be received over rail member 19, to releasably secure the bottom closure panel to the front closure panel in a fashion that permits the bottom closure panel to be removed to allow greater access into the interior of head box 1 by merely lifting the bottom closure panel and displacing hook member 20 from rail 19.

As shown, front closure panel 3 may further include a horizontal trim flange 21 that can either serve to finish the ceiling surface adjacent to the front leading edge of the head box, or that can also in some instances be used to support ceiling tile.

It will thus be appreciated that the described structure provides a simplified, lightweight and inexpensive head box that is capable of receiving and having mounted therein roller blinds, window shades and other similar types of window coverings. The mounting of end plates 2 to the structural members present in the ceiling, walls or bulkhead within which the head box is to be received provides the structural rigidity necessary to support the roller blinds. The front closure panel and the manner in which it may be releasably secured to end plates 2 presents a rigid longitudinal structure that represents a means by which bottom closure panel 4 can be releasably secured to the head box, both easily and quickly without the use of tools. It will also be appreciated that the structure of front closure panel 3 and its ability to be releasably secured to end plates 2 further presents the ability to manufacture head box 1 with a generally open top and generally open rear surface, thereby significantly reducing the amount of material required in the construction of the head box, the weight of the head box, and ultimately its cost. In instances where multiple roller blinds are to be mounted end to end, further ends plates may be positioned at various points along the longitudinal length of the head box to carry the respective ends of the blinds.

We claim:

1. A head box for receiving one or more roller blinds or the like, the head box comprising:
(i) a pair of end plates, said end plates supporting one or more roller blinds when said roller blinds are received within said head box;
(ii) a front closure panel, said front closure panel extending between said end plates and releasably securable thereto; and
(iii) a bottom closure panel to at least partially enclose the bottom of said head box, said bottom closure panel releasably securable to said front closure panel.

2. The device as claimed in claim 1 having a generally open top and a generally open back or rear surface.

3. The device as claimed in claim 2 wherein said end plates are unconnected between their respective upper and rear portions.

4. The device as claimed in claim 1 wherein said front closure panel has an end plate engaging member along its upper edge, said end plate engaging member received over a generally vertical flange on said end plates such that said front closure panel hangs from said flanges on said end plates.

5. The device as claimed in claim 4 wherein said end plates include a biasing means, said biasing means engaging said front closure panel when said front closure panel is hung from said flanges on said end plates.

6. The device as claimed in claim 5 wherein said biasing means is a spring that engages the outer surface of said front closure panel, said spring helping to prevent the unintentional removal of said end plate engaging member from said flanges.

7. The device as claimed in claim 4 where said end plate engaging member is a hook-like member.

8. The device as claimed in claim 1 wherein said end plates include fastening flanges to permit said end plates to be secured to structural members within a wall, ceiling or bulkhead.

9. The device as claimed in claim 4 wherein said front closure panel further includes a lower track, said lower track engaging a generally downwardly oriented flange portion on each of said end plates when said front closure panel is releasably secured thereto, the engagement of said lower track with the lower flange further helping to secure said front closure panel to said end plates.

10. The device as claimed in claim 9 wherein said front closure panel includes a generally upwardly oriented rail member and said bottom closure panel includes a generally downwardly oriented hook member, the hook member of said bottom closure panel releasably receivable over the rail member of said front closure panel thereby releasably securing said bottom closure panel to said front closure panel.

11. The device as claimed in claim 5 wherein said end plates include fastening strips to permit said end plates to be secured to structural members within a wall, ceiling or bulkhead.

12. The device as claimed in claim 6 wherein said front closure panel further includes a lower track, said lower track engaging a generally downwardly oriented flange portion on each of said end plates when said front closure panel is releasably secured thereto, the engagement of said lower track with said lower flanges further helping to secure said front closure panel to said end plates.

13. A head box for receiving one or more roller blinds or the like, the head box comprising:
(i) two or more end plates, said end plates supporting one or more roller blinds when said roller blinds are received within said head box;
(ii) a front closure panel, said front closure panel extending between said end plates and releasably securable thereto, said end plates including a biasing means engaging said front closure panel when said front closure panel is releasably secured to said end plates, said biasing means helping to prevent the unintentional disengagement of said front closure panel from said end plates, and;
(iii) a bottom closure panel to at least partially enclose the bottom of said head box, said bottom closure panel releasably securable to said front closure panel.

14. The device as claimed in claim 13 having a generally open upper or top surface, and a generally open rear surface.

15. The device as claimed in claim 14 wherein said front closure panel includes a hook like member along its upper edge, said hook like member received over a generally vertically oriented flange on said end plates such that said front closure panel may be hung from said flanges on said end plates with said biasing means assisting in retaining said hook like member over said flanges.
